(19) United States
(12) Patent Application Publication
(10) Pub. No.: US 2026/0187687 A1
(43) Pub. Date: Jul. 2, 2026

(54) Artificial Intelligence (AI)-Based System for Component Compound Identification

(71) Applicant: eBay Inc., San Jose, CA (US)

(72) Inventors: Rahul Ajaykumar Agarwal, Santa Clara, CA (US); Shiwam Mittal, Santa Clara, CA (US); Dyutimoy Sarkar, San Jose, CA (US)

(73) Assignee: eBay Inc., San Jose, CA (US)

(21) Appl. No.: 19/006,652

(22) Filed: Dec. 31, 2024

(51) Int. Cl. G06Q 30/0601

(52) U.S. Cl. CPC G06Q 30/0601

(57) ABSTRACT

An artificial intelligence (AI)-based system for component compound identification is described. The system may receive images associated with a product listing for an online marketplace. The product listing may be for a medicinal substance (e.g., a prescription drug). The system may generate a prompt for a large language model (LLM) based on the images and prompt the LLM to identify component compounds (e.g., ingredients) of the medicinal substance. For example, the LLM may recognize text from the images that indicates the component compounds and their respective amounts (e.g., weights or percentages). The system may generate an output based on prompting the LLM, the output indicating the identified component compounds and a determination of whether the product listing is approved or denied.

### BACKGROUND

Online marketplaces support and thus experience numerous and varied activities that facilitate transactions on the online marketplace. Some such activities may include a user (e.g., seller) posting a listing of a medicinal substance for sale, where the listing may include a description and one or more images of the drug. As some component compounds included in medicinal substances may be prohibited in certain regions or countries, administrators of the online marketplace may use a system to identify text from the images in the listing detailing the component compounds of the medicinal substance. The system may allow or take down the listing based on comparing the identified component compounds to a set of predetermined rules.

### SUMMARY

An artificial intelligence (AI)-based system for identifying component compounds of medicinal substances is leveraged with an online marketplace. In one or more implementations, a user (e.g., a seller) of the online marketplace may post a product listing for a medicinal substance (e.g., a medicinal drug). The listing may include one or more images of the medicinal substance, and the AI-based system may use the images to generate a prompt for a large language model (LLM). In some examples, the prompt may be predefined. The system may prompt the LLM (e.g., execute the LLM based on the prompt) to identify component compounds (e.g., chemical components, ingredients) of the medicinal substance. For example, if the images show a bottle of the medicinal substance with a list of the component compounds and their respective amounts in the medicinal substance, then the LLM may identify the component compounds based on the prompt. The LLM may output a list of the component compounds identified from the images, and the system may use the identified component compounds to determine whether the product listing is approved or denied, in which case the product listing is taken down from the online marketplace. In some examples, the product listing may be approved or denied based on whether particular component compounds are legal or prohibited in a given geographic region (e.g., at a particular percentage or weight).

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of an AI-based system for component compound identification in accordance with aspects of the present disclosure.

FIG. 3 depicts an example of an image of a medicinal substance in accordance with aspects of the present disclosure.

FIG. 4 depicts an example of a user interface in accordance with aspects of the present disclosure.

FIG. 5 depicts a procedure in an example implementation of an AI-based smart system for component compound identification in accordance with the aspects of the present disclosure.

FIG. 6 illustrates an example of a system that includes an example computing device that is representative of one or more computing systems and/or devices that may implement the various techniques described herein.

### DETAILED DESCRIPTION

### Overview

An AI-based system for component compound identification is described. In accordance with the described techniques, items may be available (e.g., listed) for sale on an online marketplace. In one or more implementations, the online marketplace may be accessible by decentralized computing devices that correspond to “clients” of the online marketplace, e.g., users that have accounts with the online marketplace. Users of the online marketplace may have some control over which items they list with or purchase from the online marketplace. For example, the users may determine when to list or purchase items, and may do so from different locations via a website or mobile application for the online marketplace. When a seller posts a product listing for sale, the seller may include information about the product such as a title, a description, and one or more images, and any other relevant information.

In some implementations, users may buy and sell medicinal substances (e.g., medicinal drugs) on the online marketplace. A product listing for a medicinal substance may include one or more images of the medicinal substance. For example, at least one image in the product listing may depict an active ingredients list or a drug facts panel that lists all of the component compounds (e.g., chemical components, chemical compounds) that are in the medicinal substance, as well as the respective weight (e.g., in milligrams (mg)) or percent composition of each component compound. Some component compounds may be allowed in some geographic regions but prohibited in other geographic regions (e.g., categorically or above a certain weight or percent composition). For example, the medicinal substance may be a prescription drug or a controlled substance that is prohibited in a particular country. As such, administrators of the online marketplace may employ a system to detect prohibited component compounds in medicinal substances listed for sale and remove those product listings from the online marketplace in the applicable geographic region.

In one or more implementations, the system may extract text from the images in the product listing (e.g., the ingredients list). For example, the system may use optical character recognition (OCR) to convert text in the image into a machine-readable text format. The extracted text may be provided to a rule decision system, which may include a set of pre-determined, regular expression (Regex) rules. The pre-determined rules may determine whether a particular drug or any of its individual component compounds are allowed or prohibited in a specific geographic region categorically or above a particular quantity. For example, a rule may state that component compound X is prohibited in country Y above a percent composition Z.

If all of the component compounds identified from the images satisfy the set of rules, then the system may approve the product listing for sale. Alternatively, if any of the component compounds fail to satisfy a rule (e.g., are prohibited categorically or because they are of a greater weight than what is allowed), then the system may take down the product listing, at least for the relevant geographic area.

If the set of pre-determined rules are insufficient to make a determination for a particular medicinal substance (e.g., if none of the rules account for a specific component compound), then the listing may be directed to a customer support agent (or a compliance officer) to manually review the component compounds and determine whether the medicinal substance is allowed or denied. For example, the customer support agent may manually verify each individual component compound against a list of prohibited substances in each applicable geographic region.

However, each of these pre-determined rules may be manually developed by an administrator of the online marketplace (e.g., a compliance officer). As such, this system may be inefficient at scale, particularly as more substances, weight or percent composition thresholds, and geographic areas are added. It may not be possible to review every medicinal substance listed on the online marketplace as the number of sellers increases, which may allow prohibited substances to be listed and potentially purchased. Moreover, it is unrealistic to rewrite the pre-determined rules each time a new medicinal substance is posted. Additionally, the system may be inefficient by calling each pre-determined rule one at a time for each component compound identified from the images. Sellers may also post prohibited medicinal substances by including poor-quality images (e.g., blurry, dark) in their product listings, failing to include any images at all, or including false information in an item description, such that any ingredients associated with the medicinal substance are unidentifiable.

To address these limitations, an AI-based system for component compound identification is described. In one or more implementations, the described techniques involve an AI-based system, including an LLM, implemented as part of an online marketplace. The AI-based system may be capable of identifying component compounds from product listing images and executing the LLM based on a single prompt to determine whether a product listing should be approved or denied based on the component compounds.

Specifically, a user (e.g., a seller) may post a product listing for a medicinal substance on the online marketplace. The listing may include one or more images of the medicinal substance, such as images of the medicinal substance in a bottle, where the bottle may depict some drug facts or a list of every component compound in the medicinal substance. The AI-based system may use the images to generate a prompt for an LLM. In some examples, the prompt may be predefined and applied for the relevant images. The system may prompt the LLM to identify component compounds that make up the medicinal substance, where the LLM may be trained on a data set of medicinal substance regulations in different regions, countries, and other geographic regions. The LLM may output a list of the component compounds identified from the images, and the system may use the identified component compounds to determine whether the product listing is approved or denied, in which case the product listing is taken down from the online marketplace. In some examples, the product listing may be approved or denied based on whether particular component compounds are legal or prohibited in a given geographic region (e.g., at a particular percentage or weight).

In some implementations, a product listing is approved or denied based on comparing the identified component compounds to a dataset or a set of rules (e.g., a lookup database) that indicate what drugs, chemicals, or component compounds are prohibited in a specific country either categorically or above a threshold amount. In at least one variation, the AI-based system may send the output of the LLM to a user (e.g., an administrator of the AI-based system) for their manual review, where the user may determine to approve or deny the listing based on comparing each of the identified component compounds to the dataset.

The described techniques may result in improved efficiency by enabling an LLM to identify each component compound of a medicinal substance based on a single prompt. As the LLM may be trained on a dataset of substance regulations, this approach is more efficient than individually calling pre-determined rules corresponding to each applicable substance regulation. In this way, the system may process more product listing images in less time to ensure prohibited substances are not transacted on the online marketplace. The described techniques may also improve efficiency because the processes for collecting images from product listings, analyzing the images (using the LLM), and enforcing substance regulations are all located in the same system. For example, automatically removing non-compliant listings from the online marketplace based on the output of the LLM reduces manual efforts (e.g., by compliance officers). Moreover, the described techniques may improve the accuracy of medicinal substance management on the online marketplace by supporting continuous learning of the LLM. For example, the LLM may be retrained on new substance regulations and its own outputs such that the LLM may output more accurate results over time.

In some aspects, the techniques described herein relate to a computer-implemented method including: receiving one or more images associated with a product listing for an online marketplace, wherein the product listing is for a medicinal substance; generating a prompt for an LLM based on the one or more images; prompting the LLM to identify one or more component compounds of the medicinal substance from the one or more images; and generating an output based on prompting the LLM, wherein the output indicates the one or more component compounds identified from the one or more images and a determination of whether the product listing is approved or denied.

In some aspects, the techniques described herein relate to a computer-implemented method further including sending the output to a user for manual review, wherein the determination of whether the product listing is approved or denied is based on the manual review.

In some aspects, the techniques described herein relate to a computer-implemented method further including displaying, to a user via a user interface, an indication that the product listing is denied based on the output.

In some aspects, the techniques described herein relate to a computer-implemented method, wherein each component compound of the one or more component compounds corresponds to a weight or percent composition of the medicinal substance.

In some aspects, the techniques described herein relate to a computer-implemented method, wherein identifying the one or more component compounds of the medicinal substance comprises recognizing text in the one or more images that corresponds to the one or more component compounds.

In some aspects, the techniques described herein relate to a computer-implemented method further including determining that the product listing is approved or denied based on comparing the one or more component compounds to a dataset that comprises medicinal substance regulations for a set of geographic regions.

In some aspects, the techniques described herein relate to a computer-implemented method, wherein the output indicates that none of the one or more images depicted the one or more component compounds.

In some aspects, the techniques described herein relate to a computer-implemented method, wherein the product listing is denied based on at least one component compound of the one or more component compounds having an amount that is greater than a threshold amount.

In some aspects, the techniques described herein relate to a computer-implemented method further including removing the product listing from the online marketplace based on the product listing being denied.

In some aspects, the techniques described herein relate to a system including: one or more processors; and memory storing instructions that, when executed by the one or more processors, cause the system to: receive one or more images associated with a product listing for an online marketplace, wherein the product listing is for a medicinal substance; generate a prompt for an LLM based on the one or more images; prompt the LLM to identify one or more component compounds of the medicinal substance from the one or more images; and generate an output based on prompting the LLM, wherein the output indicates the one or more component compounds identified from the one or more images and a determination of whether the product listing is approved or denied.

In some aspects, the techniques described herein relate to a system, wherein the instructions further cause the system to send the output to a user for manual review, wherein the determination of whether the product listing is approved or denied is based on the manual review.

In some aspects, the techniques described herein relate to a system, wherein the instructions further cause the system to display, to a user via a user interface, an indication that the product listing is denied based on the output.

In some aspects, the techniques described herein relate to a system, wherein each component compound of the one or more component compounds corresponds to a weight or percent composition of the medicinal substance.

In some aspects, the techniques described herein relate to a system, wherein identifying the one or more component compounds of the medicinal substance comprises recognizing text in the one or more images that corresponds to the one or more component compounds.

In some aspects, the techniques described herein relate to a system, wherein the instructions further cause the system to determine that the product listing is approved or denied based on comparing the one or more component compounds to a dataset that comprises medicinal substance regulations for a set of geographic regions.

In some aspects, the techniques described herein relate to a system, wherein the output indicates that none of the one or more images depicted the one or more component compounds.

In some aspects, the techniques described herein relate to a system, wherein the product listing is denied based on at least one component compound of the one or more component compounds having an amount that is greater than a threshold amount.

In some aspects, the techniques described herein relate to a system, wherein the instructions further cause the system to remove the product listing from the online marketplace based on the product listing being denied.

In some aspects, the techniques described herein relate to a non-transitory computer-readable media storing instructions that, when executed by one or more processors, cause the one or more processors to perform operations including: receiving one or more images associated with a product listing for an online marketplace, wherein the product listing is for a medicinal substance; generating a prompt for an LLM based on the one or more images; prompting the LLM to identify one or more component compounds of the medicinal substance from the one or more images; and generating an output based on prompting the LLM, wherein the output indicates the one or more component compounds identified from the one or more images and a determination of whether the product listing is approved or denied.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

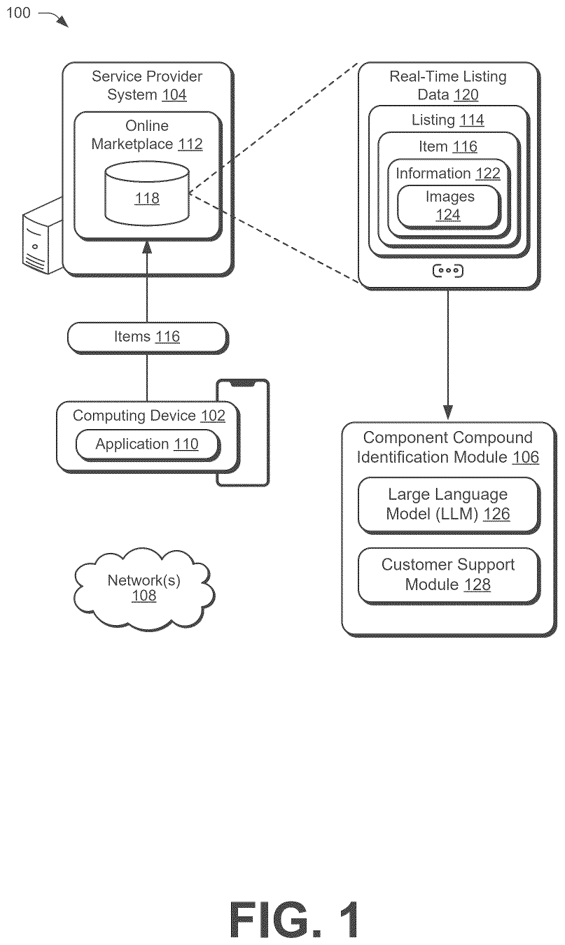

FIG. 1 is an illustration of an environment 100 in an example implementation that is operable to employ techniques described herein. The environment 100 includes a computing device 102, a service provider system 104, a component compound identification module 106. In one or more implementations, the computing device 102, the service provider system 104, and the component compound identification module 106 are communicatively coupled, one to another, via network(s) 108. One example of the network(s) 108 is the Internet, although one or more of the computing device 102, the service provider system 104, and the component compound identification module 106 may be communicatively coupled using one or more different connections or different networks in various implementations (e.g., a cloud).

Although the computing device 102 is depicted in the environment 100 as being separate from the service provider system 104 and the component compound identification module 106, in one or more implementations, an entirety or various portions of the component compound identification module 106 are implemented at or by the computing device 102 and/or the service provider system 104. In at least one implementation, for example, at least a portion of the component compound identification module 106 is implemented by an application 110 of the computing device 102 and/or using various resources of the computing device 102, such as hardware resources, an operating system, firmware, and so forth. Additionally, or alternatively, at least a portion of the component compound identification module 106 is implemented by resources (e.g., server-based storage, processing, and so on) of the service provider system 104. Alternatively, or additionally, at least a portion of the component compound identification module 106 is implemented using a third-party service, such as a web services platform that provides one or more hardware and/or other computing resources to support provision of services by web service providers.

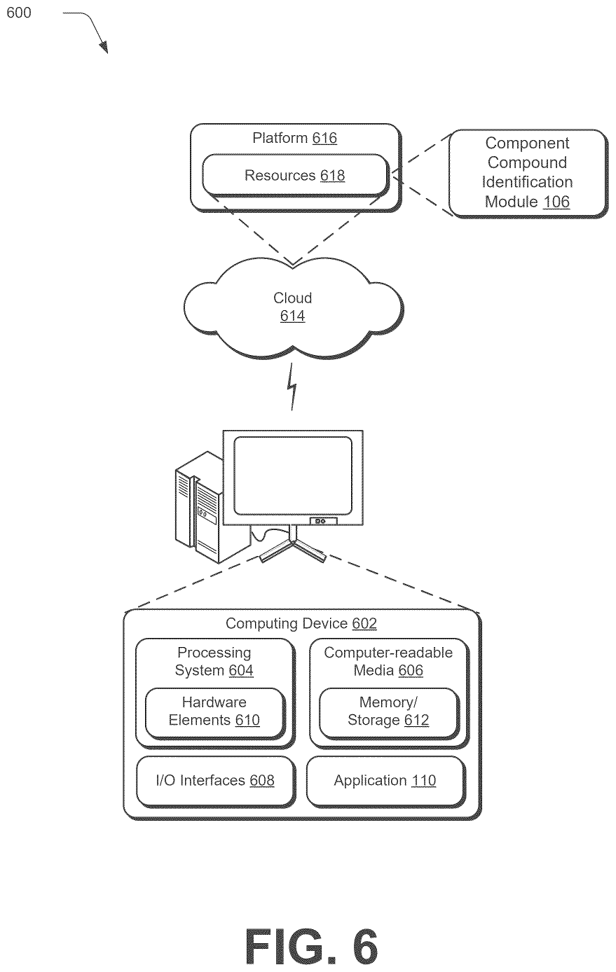

Computing devices that implement the environment 100 are configurable in a variety of ways. A computing device, for instance, is configurable as a desktop computer, a laptop computer, a mobile device (e.g., assuming a handheld configuration such as a tablet or mobile phone), an Internet-of-Things (IoT) device, a wearable device (e.g., a smart watch, a ring, or smart glasses), an augmented reality (AR)/virtual reality (VR) device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 6.

In at least one implementation, the application 110 supports communication of data across the network(s) 108, such as between the computing device 102 and the service provider system 104 and/or between the computing device 102 and the component compound identification module 106. By supporting such data communication, the application 110 provides a respective user of the computing device 102 (and users of other computing devices) access to an online marketplace 112. For example, the computing device 102 receive data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, and facilitate user interaction with web pages of the online marketplace 112's website. Another example of the application 110 is a web-based computer application of the online marketplace 112, such as a mobile application or a desktop application. The application 110 may be configured in different ways, which may enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) may facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings 114 for items 116 (e.g., also referred to herein as item listings and product listings) and to expose those listings 114 (e.g., publish them) across the network(s) 108 to one or more computing devices, including the computing device 102. For example, the online marketplace 112 may generate listings 114 for items 116 for sale and expose those listings to computing devices, such that the users of the computing devices can interact with the listings via user interfaces to initiate transactions (e.g., purchases, sales, add to wish lists, share, and so on) in relation to the respective item 116 or items 116 of the listings 114. In accordance with the described techniques, the online marketplace 112 is configured to generate listings 114 for one or more types of physical goods or property (e.g., clothing and/or clothing accessories, collectibles, furniture, decorative items, textiles, luxury items, electronics, medicinal substances or drugs, real property, physical computer-readable storage having one or more video games stored thereon, and so on), services (e.g., babysitting, dog walking, house cleaning, and so on), digital items (e.g., digital images, digital music, digital videos) that can be downloaded via the network(s) 108, and blockchain backed assets (e.g., non-fungible tokens (NFTs)), to name just a few.

In the illustrated environment 100, the online marketplace 112 may include a storage device 118, which is depicted as maintaining real-time listing data 120. The real-time listing data 120 includes a set of listings 114 of the online marketplace 112. The storage device 118 may represent one or more databases and/or other types of storage capable of storing the real-time listing data 120. Examples of the storage device 118 include, but are not limited to, mass storage and virtual storage. In one or more implementations, for example, the storage device 118 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed to such an account or tracked as a user with an account. In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items 116 listed with the online marketplace 112 (e.g., the items 116 that those users decide to list through the online marketplace 112) than the company associated with the online marketplace 112 (or its employees or agents).

Users that cause items 116 to be listed on the online marketplace 112 may be referred to as “sellers,” whereas users that purchase or otherwise obtain items listed 116 on the online marketplace 112 via its listings may be referred to as “buyers.” Sellers and buyers both interact with user interfaces of the online marketplace 112 (e.g., via the application 110) to perform the desired functionality. In addition, an individual user of the online marketplace 112 can interact via the interfaces to be both a seller and a buyer on the online marketplace 112, such as by interacting with the user interfaces to have caused one or more items 116 to be listed on the online marketplace 112 and by interacting with the user interfaces to purchase one or more items 116 from the listings of the online marketplace 112.

A user that is a seller, for instance, may interact with one or more user interfaces of the online marketplace 112 (e.g., output via the application 110) to provide information about one or more items 116 which the user is causing to be listed on the online marketplace 112. Such user interfaces may include prompts that instruct, or guide, users that are sellers to provide information 122 about items 116 being listed. Examples of information that such interfaces prompt sellers for and that those users provide include, but are not limited to, a title, description (of the item 116), one or more prices (e.g., to purchase the item 116 now and/or a minimum starting bid for the item 116), brand information, size, year, color(s), shipping information (e.g., cost and/or types available), delivery information, return information, payment information, images 124, videos, models, authenticity information, item history (e.g., chain of custody), and condition (of the item 116), to name a few.

One or more portions of such information may be referred to herein as attributes of the listing 114. For example, a title of the listing 114 may be an attribute of the listing, a description of the item 116 being listed may be an attribute of the listing 114, one or more images uploaded or selected for the listing 114 may be one or more attributes of the listing 114, color(s) of the item 116 may be an attribute of the listing 114, one or more categories of the item 116 may be attributes of the listing 114, and so forth.

In one or more implementations, the categories of the online marketplace 112 include a category hierarchy (e.g., a tree structure) in which more specific child categories (e.g., smartphones or allergy medicine) fall under more generic parent categories (e.g., electronics or medicinal substances, respectively). Additionally, or alternatively, the categories of the online marketplace 112 include a plurality of sector categories (e.g., sports) each including one or more highest-level or root categories (e.g., sports memorabilia, sporting goods). Given this, the categories associated with a listing 114 for an item 116 can include the categories of the category hierarchy that the item 116 falls under (e.g., from the root category to the lowest-level or leaf category), and one or more sector categories to which the item 116 belongs.

In one or more implementations, the online marketplace 112 saves and maintains the information 122 for a listing 114 in the storage device 118 in fields of a data structure or data record populated for the listing 114, where a given field and the information 122 populated and maintained for the given field correspond to a particular attribute of the listing 114. For instance, a ‘title’ field of such a data structure or data record may be populated with information 122 (e.g., text) input into a user interface by a seller of a listing 114. The title field and the information 122 input by the user as the title of the listing 114 correspond to an attribute of the listing 114, e.g., a title attribute. In one or more implementations, one or more of the attributes of a listing 114 may be derived and then populated by the online marketplace 112, such as by the online marketplace 112 processing one or more portions of the information input by a user to populate one or more respective attributes of the listing 114.

The component compound identification module 106 may support an LLM 126 and a customer support module 128. The LLM 126 may be a multimodal LLM capable of processing multiple types of inputs, such as text, images 124, and videos. For example, the multimodal LLM may receive an image (e.g., as an input) and output text. In some implementations, the LLM 126 may be trained on various data including medicinal substance regulations in different geographic regions. For example, the LLM 126 may be trained on a set of rules that indicate what chemicals or component compounds are prohibited in a specific country either categorically or above a particular threshold amount. The customer support module 128 may provide a platform for one or more customer support agents (e.g., including compliance officers or other administrative employees of the online marketplace) to review listings 114.

In accordance with the described techniques, a seller may list one or more items 116 or products for sale on the online marketplace 112. The items 116 may include medicinal substances or drugs. In the corresponding listing 114, the seller may include information 122 that is relevant to the item 116 including a title (e.g., a name of the medicinal substance), a description (e.g., including information such as a manufacturer of the medicinal substance, its uses, etc.), and one or more images 124. At least one of the images 124 may depict the medicinal substance in the bottle, and the bottle may have some text on it. For example, the front of the bottle may depict the name of the medicinal substance, the manufacturer, and other information, while the back of the bottle may depict a ‘drug facts’ or ‘active ingredients’ panel that lists each component compound included in the medicinal substance, and a weight (e.g., in mg) or a percent composition of each component compound.

Once a listing 114 of a medicinal substance has been posted by a seller, the component compound identification module 106 may receive the images 124 that were included with the listing 114. The component compound identification module 106 may generate a prompt for the LLM 126 to analyze the component compounds of the medicinal substance in the listing 114 to identify whether any of the component compounds are prohibited in a particular geographical region (e.g., a country). In some examples, the prompt may predefined for the LLM 126. The system may prompt the LLM 126 (e.g., the LLM 126 may execute based on the prompt) to identify the component compounds of the medicinal substance from the images 124. For example, if the images 124 depict the back of the bottle, the LLM 126 may recognize the text in the images and identify the component compounds and their respective weights or percent compositions from the text. Based on prompting the LLM 126, the component compound identification module 106 may output a list (e.g., in a text format) of the component compounds identified from the images 124. In some examples, the component compound identification module 106 may also output the respective weights or percent compositions of each component compound. Additionally, the component compound identification module 106 may output a determination of whether the listing 114 should be approved or denied based on the component compounds. For example, if all component compounds are allowed in a specified geographic region, then the component compound identification module 106 may indicate that the medicinal substance is approved, and the listing 114 will be allowed on the online marketplace 112 for sale. Alternatively, if any one of the component compounds are prohibited in the specified geographic region, then the component compound identification module 106 may indicate that the medicinal substance is denied, and the listing 114 will be removed from the online marketplace 112.

Having considered an example of an environment, consider now a discussion of some example details of the techniques for using an AI-based system for component compound identification in accordance with one or more implementations.

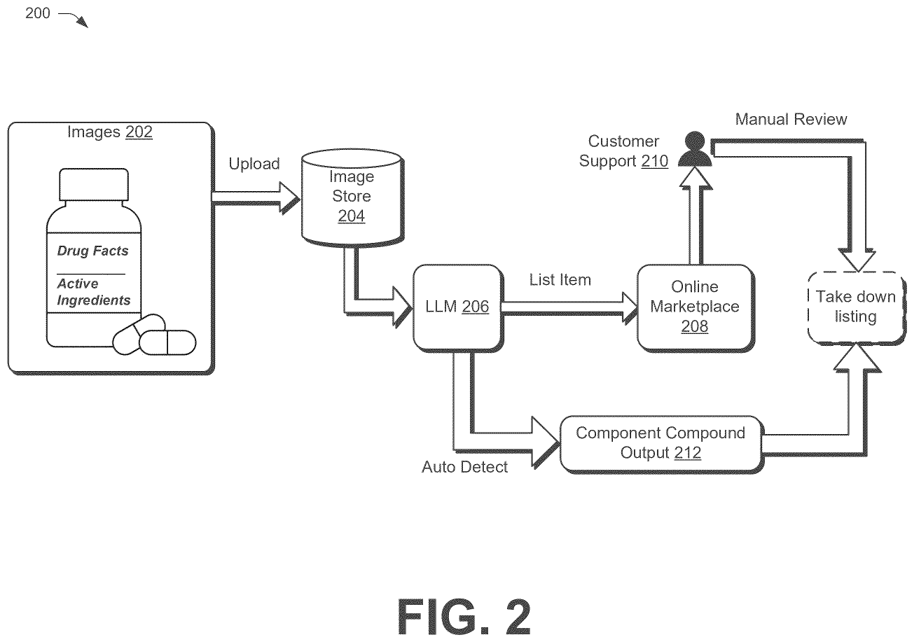

FIG. 2 depicts an example of an AI-based system 200 for component compound identification in accordance with aspects of the present disclosure. The AI-based system 200 may be implemented in or otherwise supported by the computing device 102, the service provider system 104, and the component compound identification module 106, as described with reference to FIG. 1. For instance, the AI-based system 200 may include an image store 204, which may be an example of a storage device 118, an LLM 206, which may be an example of an LLM 126, and an online marketplace 208, which may be an example of the online marketplace 112.

In the AI-based system 200, a seller may list one or more items or products for sale on the online marketplace 112. For example, the seller may list a medicinal substance, which may be a prescription drug, a vitamin supplement, or any other type of medicinal substance. In the corresponding listing, the seller may include relevant information about the medicinal substance including a title (e.g., a name of the medicinal substance), a description (e.g., information such as a manufacturer of the medicinal substance, its uses, etc.), and one or more images 202, which may be examples of the images 124 described with reference to FIG. 1. In some examples, the seller may take the images using a computing device (e.g., a smartphone, tablet, or laptop camera) or the images may be uploaded from some image database the seller may have access to.

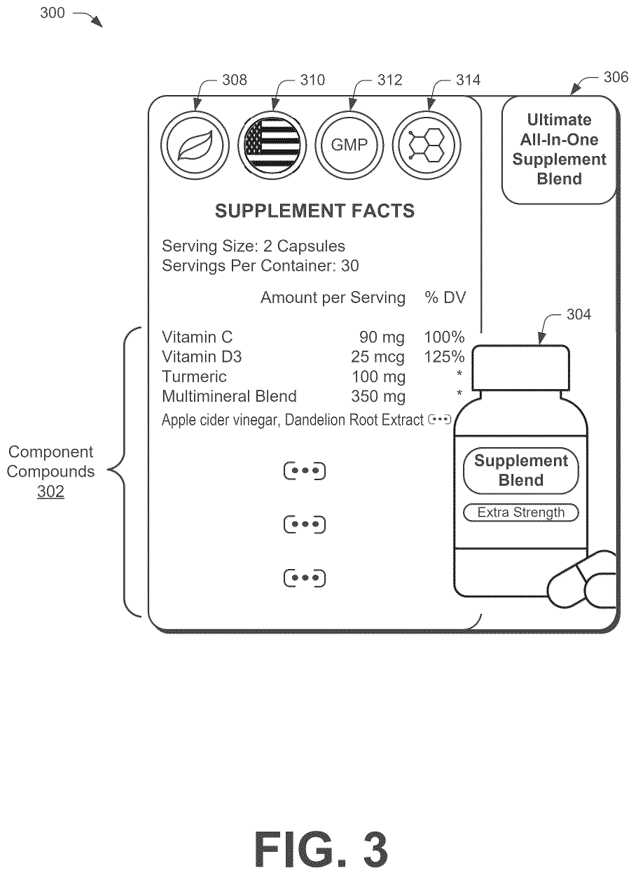

At least one of the images 202 may depict the medicinal substance in the bottle, and the bottle may have some text on it. For example, the image 202 may depict medicinal substance in a bottle, where the front and/or back of the bottle may depict information about the medicinal substance such as a name, manufacturer, ingredient information such as a ‘drug facts’ panel or an ‘active ingredients’ list, and other information. The ingredient information may list each component compound (e.g., chemical components, chemical compounds) included in the medicinal substance, and an amount of each component (e.g., a weight or a percent composition). An example of the image 202 is described with reference to FIG. 3.

The images 202 may be uploaded to an image store 204, which may represent one or more databases and/or other types of storage capable of storing real-time image data. The image store 204 may store image data for any number of listings of products in different categories, however only images related to medicinal substances will be provided to the LLM 206.

The LLM 206 may be a multimodal LLM capable of processing multiple types of inputs, such as text, images 202, and videos. In some implementations, the LLM 206 may be trained on various data including medicinal substance regulations in different geographic regions. For example, the LLM 206 may be trained on a set of rules (e.g., a lookup database) that indicate what drugs, chemicals, or component compounds are prohibited in a specific country either categorically or above a threshold amount. This data may include various different modes or types of data, including text data (e.g., names, ingredients, etc.) and image data (e.g., images of medicinal substances), among others. In some examples, the data may be manipulated such that the data may be utilized by the LLM 206 more efficiently. In some implementations, the LLM 206 may be further trained on medicinal substances listed on the online marketplace 208 for the first time so the LLM 206 is able to subsequently recognize new drugs or component compounds and identify component compounds more accurately.

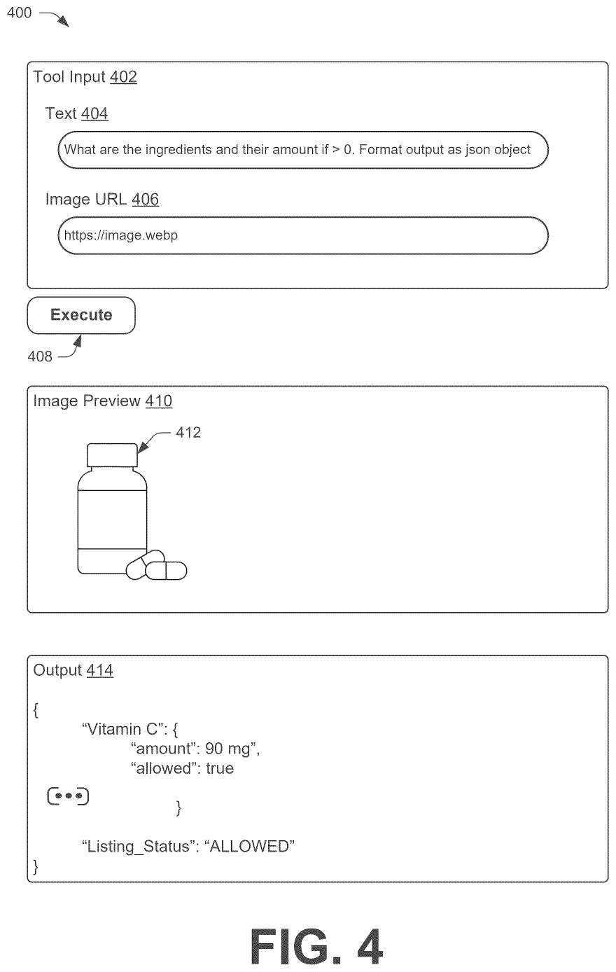

The images 202 may be used to generate a prompt for the LLM 206. The prompt may be a question, instruction or other input in a text format (e.g., JavaScipt Object Notation (JSON)) that guides the LLM 206 to generate a specific response or output. For example, as described with reference to FIG. 4, the prompt may include the following text: “What are the ingredients and their amount if>0. Format output as json object.” This prompt may instruct the LLM 206 to identify the ingredients or component compounds of a medicinal substance and their respective amounts based on the images 202 and provide an output in a JSON format. The prompt instructs the LLM 206 to include the ingredients and their amounts (e.g., in weight or percent composition) if greater than zero (e.g., 0 mg or 0%). The prompt may be modified to obtain different results from the LLM 206. In some examples, the prompt may predefined for the LLM 206.

The system may prompt the LLM 206 to identfy the component compounds of the medicinal substance from the images 202. For example, if the images 202 depict some sort of ingredients list, the LLM 206 may recognize the text in the images and identify the component compounds and their respective weights or percent compositions from the text. Based on the prompt asking the LLM 206 to only find ingredients, the LLM 206 may refrain from identifying any other text on the bottle, such as a serving size, the name of the medicinal substance, and any other text not including a component compound. In this way, the LLM 206 may identify which of the images 202 include text that is relevant to the component compounds and which do not. In addition, the LLM 206 may recognize text from images in languages other than English such that the LLM 206 may identify component compounds in many languages for many different geographic regions.

Also based on prompting the LLM 206, the LLM 206 may output a list of the identified component compounds 212 and their amounts (if over zero) in a text format (e.g., JSON). For example, the output component compounds and amounts may include: Acetaminophen 500 mg, Phenylephrine HCl 7.5 mg, and Chlorpheniramine Maleate 2 mg. In some examples, if a component compound is allowed but only below a threshold amount, then the output may also indicate the threshold amount. For example, the output may indicate that a component compound is allowed at a percent composition below 50% but is prohibited above 50%.

Using the information output by the LLM 206, the system may determine to approve or deny the listing. For example, the component compounds identified by the LLM 206 may be compared to a set of data (e.g., a lookup database) that indicates what drugs, chemicals, or component compounds are prohibited in a specific geographic region either categorically or above a threshold amount. If all the component compounds are allowed based on comparing them to the data, then the listing may be approved and posted on the online marketplace 208. If the entire medicinal substance or any one of the component compounds in the substance is prohibited in a specific geographic region, the listing will be denied and taken down from the online marketplace 208 (if already posted) or not posted at all. In addition to the list of component compounds and their amounts identified by the LLM 206, the system may output the determination of whether the listing should be allowed or denied based on the component compounds.

In some examples, a listing may be passed to a customer support agent 210 for manual review. For example, the customer support agent 210 may review listings on a random basis to check that the system is approving or denying the listings correctly, or the system may forward listings that include new medicinal substances or component compounds the LLM 206 has not encountered or been trained on yet. The customer support agent may verify each individual component compound identified in the listing (e.g., from the images 202) against a data set of prohibited substances in each applicable geographic region and approve or deny the listing accordingly. In some examples, feedback from the customer support agent 210 may be used to continuously retrain the LLM 206 and improve its ability to recognize new component compounds.

FIG. 3 depicts an example of an image 300 of a medicinal substance listed on an online marketplace in accordance with aspects of the present disclosure. The image 300 may be an example of an image 202 as described with reference to FIG. 2. The image 300 may depict an advertisement for a medicinal substance. In the example of FIG. 3, the medicinal substance may be a supplement blend, but the medicinal substance may alternatively be a prescription drug, a topical medicine, or any other type of medicinal substance.

The image 300 may depict details about the makeup of the medicinal substance under a heading such as “supplement facts,” “drug facts,” “active ingredients,” or some other title. In some examples, the details may include a serving size (e.g., 2 capsules) and a number of servings per container (e.g., 30). In addition, the details may include a list of ingredients or component compounds 302 that make up the medicinal substance in what amounts. In the example of the image 300, the amount of each component compound 302 may be given as an amount per serving (e.g., weight in mg or micrograms (mcg)) and a percent daily value (DV), however, the amount may additionally, or alternatively be provided as a percent composition. For example, the component compounds 302 may include 90 mg of Vitamin C (which is a 100% DV), 25 mcg of Vitamin D3 (which is a 125% DV), 100 mg of Turmeric (DV not applicable as indicated by an asterisk) and 350 mg of a multimineral blend (DV not applicable). In some cases, a component compound 302, such as the multimineral blend, may be a mixture of ingredients, which are also listed in the medicinal substance details. For example, the multimineral blend may include apple cider vinegar, dandelion root extract, and additional ingredients or compounds.

The image 300 may also include a depiction of the medicinal substance in a bottle 304 and any number of badges or symbols such as a badge 306, a natural ingredient symbol 308, a “made in USA” symbol 310, a good manufacturing practices (GMP)-certified symbol 312, and a formula symbol 314.

As described herein with reference to FIG. 2, an LLM may recognize text from the image 300 and from that text, identify the component compounds 302 or ingredients of the corresponding medicinal substance. In the example of the image 300, the LLM may identify the component compounds 302, including any ingredient mixtures included in the supplement facts. That is, the LLM may identify Vitamin C, Vitamin D3, Turmeric, and the Multimineral Blend including apple cider vinegar, dandelion root extract, and additional ingredients in the Multimineral Blend as component compounds 302. The LLM may also identify the respective amounts of each of these component compounds 302. In this way, the LLM may differentiate between text in the image 300 that is a component compound 302 and any other text, such as the text “Ultimate All-In-One Supplement Blend” on the badge 306, the symbols 308, 310, 312, and 314, the text “Supplement Blend” (e.g., a title) and “extra strength” on the bottle 304, and the text in the supplement facts relating to servings.

FIG. 4 depicts an example of a user interface 400 for AI-based system for component compound identification in accordance with aspects of the present disclosure.

The user interface 400 may be utilized by an administrator of the AI-based system to generate a prompt for an LLM to identify one or more component compounds of a medicinal substance as described herein. The user interface 400 may include a tool input 402 window that includes a text field 404 and an image URL field 406. The administrator may type a prompt into the text field 404, such as “What are the ingredients and their amount if>0. Format output as json object.” That is, the prompt may instruct the LLM to identify the ingredients or component compounds of a medicinal substance and their respective amounts based on images of the medicinal substance and provide an output in a JSON format. The prompt instructs the LLM to include the ingredients and their amounts (e.g., in weight or percent composition) if greater than zero (e.g., 0 mg or 0%). The prompt may be modified to obtain different results from the LLM, and in some examples, the prompt may predefined (e.g., instead of being typed into the text field 404 at runtime). The administrator may type a URL in the image URL field 406 that corresponds to an image of the medicinal substance. For example, the URL may be to a listing of the medicinal substance on the online marketplace. The administrator may select the “execute” button 408 to prompt the LLM (e.g., execute the LLM based on the prompt).

Based on the prompt, the LLM may output an image preview 410 based on the information input into the text field 404 and the image URL field 406. The image preview 410 may show an image 412 of the medicinal substance (e.g., the same image that a user uploaded in the corresponding listing that lists the component compounds of the medicinal substance).

Based on prompting the LLM, the AI-system may display an output 414 via the user interface 400. The output 414 may be generated in part by the LLM and in part by the AI-system itself. In the example of the user interface 400, the output 414 may include a list of the component compounds and their respective amounts in a text format (e.g., JSON) as identified by the LLM. For example, the list of component compounds may include “Vitamin C” at an amount “90 mg.” The AI-system may then compare the output component compounds to a set of rules (e.g., a lookup database) indicating which drugs, chemicals, or component compounds are prohibited in a specific country either categorically or above a threshold amount. The AI-system may then include an “allowed” status in the output 414 for each component compound, which indicates whether that component compound is allowed in that amount (e.g., “true”), and an overall “listing status” of allowed assuming that all other component compounds identified by the LLM are also allowed. If the AI-system determines that a component compound is prohibited based on the rules, then the output 414 may indicated the “allowed” status as “false,” and the “listing status” will be “blocked.”

Having discussed exemplary details of an AI-based system for component compound identification, consider now some examples of procedures to illustrate additional aspects of the techniques.

### Example Procedures

This section describes examples of procedures for an AI-based smart actioning system. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

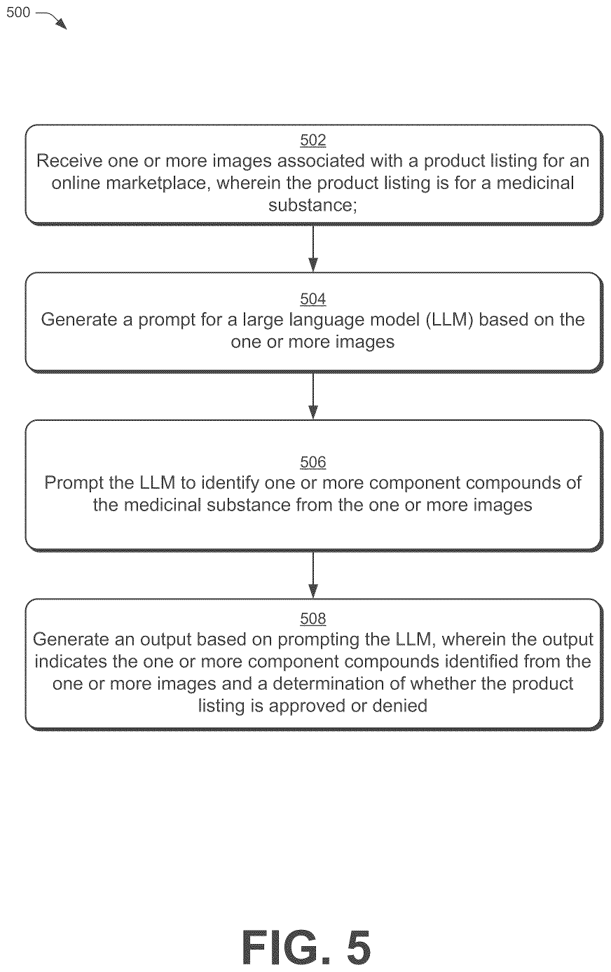

FIG. 5 depicts a procedure 500 in an example implementation of an AI-based system for component compound identification.

One or more images associated with a product listing for an online marketplace is received, where the product listing is for a medicinal substance (block 502). By way of example, a user (e.g., seller) may post listing 114 a medicinal substance (e.g., a prescription drug, a vitamin supplement, etc.) for sale on the online marketplace 112. The listing 114 may include one or more images 124 of the medicinal substance.

A prompt for an LLM is generated based on the one or more images (block 504). By way of example, the prompt may include text instructions for the LLM to identify one or more component compounds (e.g., ingredients) from the images 124.

The LLM is prompted to identify one or more component compounds of the medicinal substance from the one or more images (block 506). By way of example, the LLM may recognize text in the images 124 to identify the component compounds. For example, the text in the image may correspond to an ingredients list or “drug facts” on the back of a bottle of the medicinal substance. In some examples, the LLM may also identify amounts (e.g., weights or percent compositions) corresponding each component compound.

An output is generated based on prompting the LLM, where the output indicates the one or more component compounds identified from the one or more images and a determination of whether the product listing is approved or denied (block 508. By way of example, the system may determine whether the product listing is approved or denied based on comparing the component compounds identified by the LLM to a set of rules indicating which component compounds and medicinal substances are allowed at which amounts in different geographic regions.

Having described examples of procedures in accordance with one or more implementations, consider now an example of a system and device that can be utilized to implement the various techniques described herein.

FIG. 6 illustrates an example of a system 600 generally that includes an example of a computing device 602 that is representative of one or more computing systems and/or devices that may implement the various techniques described herein. This is illustrated through inclusion of the application 110 and the component compound identification module 106. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random access memory (RAM)) and/or nonvolatile media (such as read only memory (ROM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving one or more images associated with a product listing for an online marketplace, wherein the product listing is for a medicinal substance;
generating a prompt for a large language model (LLM) based on the one or more images;
prompting the LLM to identify one or more component compounds of the medicinal substance from the one or more images; and
generating an output based on prompting the LLM, wherein the output indicates the one or more component compounds identified from the one or more images and a determination of whether the product listing is approved or denied.

2. The computer-implemented method of claim 1, further comprising:
sending the output to a user for manual review, wherein the determination of whether the product listing is approved or denied is based on the manual review.

3. The computer-implemented method of claim 1, further comprising:
displaying, to a user via a user interface, an indication that the product listing is denied based on the output.

4. The computer-implemented method of claim 1, wherein each component compound of the one or more component compounds corresponds to a weight or percent composition of the medicinal substance.

5. The computer-implemented method of claim 1, wherein identifying the one or more component compounds of the medicinal substance comprises recognizing text in the one or more images that corresponds to the one or more component compounds.

6. The computer-implemented method of claim 1, further comprising:
determining that the product listing is approved or denied based on comparing the one or more component compounds to a dataset that comprises medicinal substance regulations for a set of geographic regions.

7. The computer-implemented method of claim 1, wherein the output indicates that none of the one or more images depicted the one or more component compounds.

8. The computer-implemented method of claim 1, wherein the product listing is denied based on at least one component compound of the one or more component compounds having an amount that is greater than a threshold amount.

9. The computer-implemented method of claim 1, further comprising:
removing the product listing from the online marketplace based on the product listing being denied.

10. A system comprising:
one or more processors; and
memory storing instructions that, when executed by the one or more processors, cause the system to:
receive one or more images associated with a product listing for an online marketplace, wherein the product listing is for a medicinal substance;
generate a prompt for a large language model (LLM) based on the one or more images;
prompt the LLM to identify one or more component compounds of the medicinal substance from the one or more images; and
generate an output based on prompting the LLM, wherein the output indicates the one or more component compounds identified from the one or more images and a determination of whether the product listing is approved or denied.

11. The system of claim 10, wherein the instructions further cause the system to:
send the output to a user for manual review, wherein the determination of whether the product listing is approved or denied is based on the manual review.

12. The system of claim 10, wherein the instructions further cause the system to:
display, to a user via a user interface, an indication that the product listing is denied based on the output.

13. The system of claim 10, wherein each component compound of the one or more component compounds corresponds to a weight or percent composition of the medicinal substance.

14. The system of claim 10, wherein identifying the one or more component compounds of the medicinal substance comprises recognizing text in the one or more images that corresponds to the one or more component compounds.

15. The system of claim 10, wherein the instructions further cause the system to:
determine that the product listing is approved or denied based on comparing the one or more component compounds to a dataset that comprises medicinal substance regulations for a set of geographic regions.

16. The system of claim 10, wherein the output indicates that none of the one or more images depicted the one or more component compounds.

17. The system of claim 10, wherein the product listing is denied based on at least one component compound of the one or more component compounds having an amount that is greater than a threshold amount.

18. The system of claim 10, wherein the instructions further cause the system to:
remove the product listing from the online marketplace based on the product listing being denied.

19. A non-transitory computer-readable media storing instructions that, when executed by one or more processors, cause the one or more processors to perform operations including:
receiving one or more images associated with a product listing for an online marketplace, wherein the product listing is for a medicinal substance;
generating a prompt for a large language model (LLM) based on the one or more images;
prompting the LLM to identify one or more component compounds of the medicinal substance from the one or more images; and
generating an output based on prompting the LLM, wherein the output indicates the one or more component compounds identified from the one or more images and a determination of whether the product listing is approved or denied.

20. The non-transitory computer-readable media of claim 19, wherein the instructions further cause the one or more processors to:
send the output to a user for manual review, wherein the determination of whether the product listing is approved or denied is based on the manual review.
